(19) United States
(12) Patent Application Publication
(10) Pub. No.: US 2026/0324940 A1
(43) Pub. Date: Oct. 22, 2026

(54) SELF-ADJUSTING DISHWASHER LATCH WITH SELF-HEALING STRIKER

(71) Applicant: ILLNOIS TOOL WORKS INC., Glenview, IL (US)

(72) Inventors: Joel Charles BRAGG, Waterford, WI (US); Corey Martin Pruess, Racine, WI (US); John D. Stolz, Milwaukee, WI (US)

(73) Assignee: ILLINOIS TOOL WORKS INC., Glenview, IL (US)

(21) Appl. No.: 19/652,635

(22) Filed: Apr. 20, 2026

Related U.S. Application Data
(60) Provisional application No. 63/792,587, filed on Apr. 22, 2025.

(51) Int. Cl. A47L 15/42; E05B 15/02; E05B 15/04

(52) U.S. Cl. CPC A47L 15/4259; E05B 15/0205; E05B 15/04; E05B 2015/0403

(57) ABSTRACT

A door lock assembly for use with an appliance having a door includes a housing positioned with respect to the appliance. A latch is provided within the housing, wherein the latch is movable with respect to the housing among a locked position, an intermediate position, and a released position. A slider is connected to the latch, wherein the slider is configured to be movable forward and backward within the housing so that the latch moves among the locked position, the intermediate position, and the released position. A striker is positioned with respect to the door, the latch engageable with the striker in the locked position and the intermediate position.

### CROSS REFERENCE TO RELATED APPLICATION

This application claims the benefit of U.S. Provisional Application, Ser. No. 63/792,587, filed on 22 Apr. 2025. The co-pending provisional application is hereby incorporated by reference herein in its entirety and is made a part hereof, including but not limited to those portions which specifically appear hereinafter.

### BACKGROUND OF THE INVENTION

### Field of the Invention

The present disclosure relates to a door lock, and in particular to an appliance door lock for a household appliance.

### Discussion of Related Art

Generally, a door lock is mounted to a door and/or tub of an appliance such as a dishwasher. When the door is to be closed, a pushing force is applied to the door, and a latch is then inserted into the door lock to lock the door; and when the door is to be opened, a pulling force is applied to the door, and the latch is then withdrawn from the door lock. The door lock is required to lock the door of the dishwasher for safety of use when the dishwasher is in operation to prevent the dishwasher from being opened while the dishwasher is in operation.

### SUMMARY OF THE INVENTION

The present disclosure provides a door lock assembly, comprising: a housing, a latch, a slider, and a striker wherein the latch is provided within the housing, the latch movable with respect to the housing so as to assume a locked position, an intermediate position, and a released position relative to the striker; and the slider is connected to the latch, and the slider is configured to be movable backward and forward, wherein when the slider moves, the latch can move among the released position to the intermediate position to the locked position, and vice-versa.

According to the door lock as described above, the slider elastic device comprises a pair of springs, wherein the pair of springs are respectively connected to the slider, and each of the pair of springs has a first end connected to the housing, and a second end connected to the slider.

According to the door lock as described above, the latch comprises a pair of locking arms, each of the pair of locking arms comprises locking ends being movable toward or away from each other to allow the pair of locking arms to reach the locked position and the released position. According to the door lock as described above, the pair of locking arms are capable of retaining a locked component between the pair of locking arms, and the locking ends of the pair of locking arms are configured to be able to prevent the locked component from being disengaged from the pair of locking arms.

According to the door lock as described above, the locking ends of the pair of locking arms comprise a pair of protrusions bent toward each other, when the pair of locking arms are in the locked position, the pair of protrusions are located on one side of the locked component in the movement direction of the slider so as to prevent the locked component from moving toward the locking ends in the movement direction of the slider.

According to the door lock as described above, the pair of locking arms each comprise a connecting end being rotatably or slidably connected to the slider; and the door lock further comprises locking arm return devices being respectively connected to the pair of locking arms and capable of applying spring forces to the pair of locking arms to maintain the pair of locking arms in the released position. According to the door lock as described above, the pair of locking arms each has a locking arm outer section, and when the slider moves from the first position to the second position, the locking arm outer sections of the pair of locking arms are pressed by the pair of limiting portions such that the pair of locking arms moves from the released position to the locked position and/or the intermediate position.

According to the door lock as described above, the door lock further comprises a switch assembly transitioning from a first switch state to a second switch state when the slider reaches a desired position.

The present disclosure provides an appliance, the appliance comprising the door lock assembly as described above.

The door lock assembly of the present disclosure allows for the locking and unlocking of a locked part. The door lock of the present disclosure comprises a slider, locking arms, striker, and springs, which can improve the perception of control during door opening and closing.

One disadvantage of using a door lock with overcenter springs is that it can be tampered with or accidentally moved into a door closed position when the door is actually open. For this reason, it is desirable in the subject invention to have a self-healing latch. That is, the user can simply close the appliance door and open it again to place the latch back into an ordinary operating condition. Such a self-healing latch is, in part, described below and one object of the subject invention.

It is further desirable that the subject door lock assembly will minimize variations in door opening feel caused by inconsistent installations that may result in otherwise misalignment between a door lock and a striker.

### BRIEF DESCRIPTION OF SEVERAL VIEWS OF THE DRAWINGS

FIG. 1 is a perspective view of a door lock according to one embodiment of the present disclosure;

FIG. 2 is an exploded top perspective view of a door lock according to one embodiment;

FIG. 3 is an exploded top perspective view of the door lock shown in FIG. 2;

FIG. 4 is a top perspective view of a striker for use with a door lock according to one embodiment;

FIG. 5 is a top view of a latch and a striker in an intermediate position according to an embodiment;

FIG. 6 is a top view of the latch and striker of FIG. 5 in a locked position;

FIG. 7 is a side perspective view of a housing and carriage according to one embodiment;

FIG. 8A is a top view of the housing and carriage shown in FIG. 7 positioned at one edge of movement;

FIG. 8B is a top view of the housing and carriage shown in FIG. 7 positioned at an opposite edge of movement from FIG. 8A;

FIG. 9 is a side cross-sectional view of the housing and carriage shown in FIG. 7; and

FIG. 10 is a bottom cross-sectional view of the housing and carriage shown in FIG. 7.

### DESCRIPTION OF PREFERRED EMBODIMENTS

Various specific embodiments of the present disclosure are described below with reference to the accompanying drawings which constitute part of this description. It should be understood that although the terms such as “front,” “rear,” “back,” “upper,” “lower,” “side,” “left,” and “right” indicating directions are used in the present disclosure to describe various exemplary structural parts and elements of the present disclosure, these terms used herein are merely used for ease of description and are determined based on the exemplary orientation shown in the accompanying drawings. Since the arrangements in the embodiments disclosed in the present disclosure may be in various directions, these terms indicating directions are merely illustrative and should not be considered as limitations. If possible, the same or similar reference numerals used in the present disclosure refer to the same components.

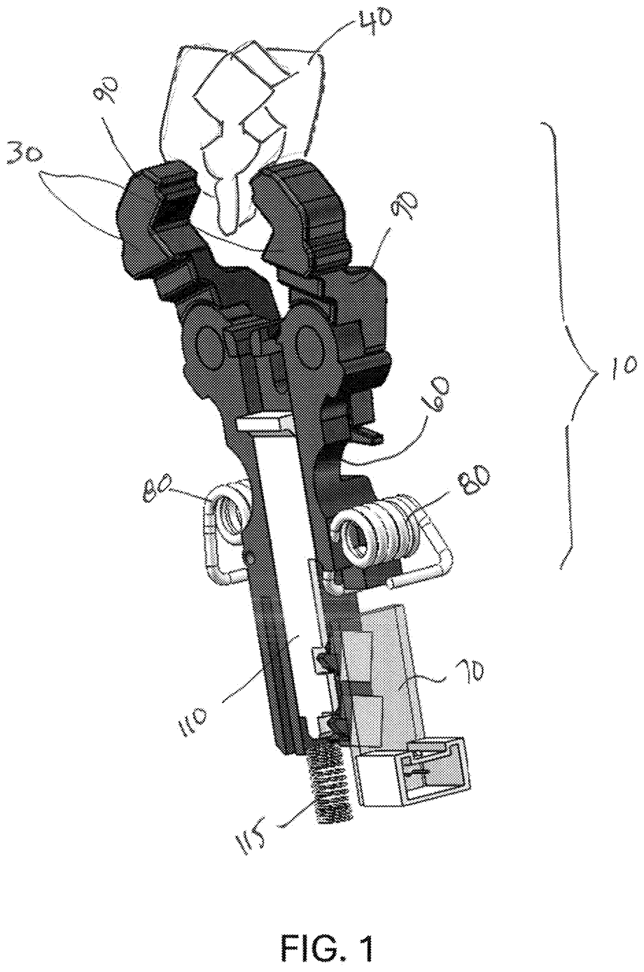

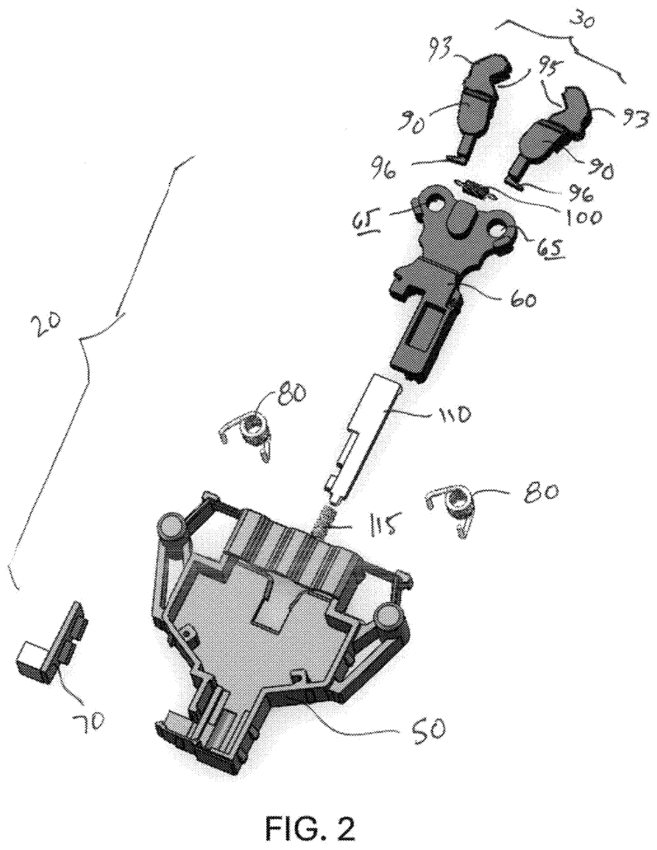

FIG. 1 is a perspective view of a door lock assembly 10 of the present disclosure, and FIGS. 2 and 3 are exploded views of a door lock 20 according to one embodiment. US Publication 2024/0360698 shows another embodiment of a door lock assembly using a pair of overcenter springs and is incorporated herein by reference. In the present application, a door lock assembly 10 includes a door lock 20 having a latch 30 that is mounted to a cabinet of a household appliance and a striker 40 mounted to a door of the household appliance. The door lock 20 and latch 30 can mate with the striker 40 to lock or release the latch 30, so as to lock and release the door. The door lock 20 preferably comprises a housing 50, a slider 60, a latch 30 including a pair of locking arms 90, and a switch assembly 70. Each of the slider 60, the switch assembly 70, and the latch 30 is accommodated at least partially inside the housing 50.

The slider 60 is preferably movable with respect to the housing 50. One end of each of the pair of locking arms 90 is connected to the slider 60, and the other ends thereof can move closer to or away from each other as driven by the slider 60, so as to lock or release the latch 30. The latch 30 preferably includes a latch spring 100 arranged between the pair of locking arms 90 to provide a spring force to allow the locking arms to move away from each other.

The slider 60 preferably further comprises a pair of slider springs 80, which may include torsion springs in an embodiment of the present disclosure. The slider springs 80 are preferably arranged on either side of the slider 60, and each of the slider springs 80 connect the slider 60 to the housing 50, so as to provide a spring force between the housing 50 and the slider 60. The spring force provided by the slider springs 80 preferably changes during a forward and backward movement of the slider 60 relative to the housing 50. The switch assembly 70 is preferably arranged at one side of the slider 60 and/or the housing 50, and is preferably triggered during the movement of the slider 60.

FIGS. 2 and 3 best show a perspective view of the housing in one embodiment. As shown, the housing 50 preferably includes structure sufficient to accommodate the slider 60 and the associated switch assembly 70 as well as a forward opening. The locking arms 90 are movable in the forward opening and preferably engageable with the striker 40 (not shown in FIGS. 2-3).

The switch assembly 70 is preferably arranged generally along one side of the housing 50. The switch assembly 70 may include one or more switches functionally connected to one or more operations of the appliance. As the latch 30 moves between positions, the switch assembly 70 preferably transitions from at least a first switch state, such as “on,” to at least a second switch state, such as “off.”

FIGS. 2 and 3 additionally show a perspective view of the slider 60. The slider 60 preferably includes a pair of mounting holes 65 for receiving corresponding parts of the locking arms 90 in a pivoting engagement. In one embodiment, a secondary slider 110 may be positioned within the slider 60 to facilitate engagement with both the striker 40 and the switch assembly 70. In this way the secondary slider 110 may slide within the slider 60 which further may slide within the housing 50.

The slider 60 may further be connected to the housing 50 with a pair of slider springs 80. The slider springs 80 in one embodiment comprise a pair of torsion springs together with suitable mounting portions between the slider 60 and the housing 50. The secondary slider 110 may include a secondary spring 115 for creating a biased arrangement of the secondary slider 110 relative to the housing 50.

FIGS. 2 and 3 show perspective views of a pair of locking arms 90 comprising the latch 30. The locking arms 90 are preferably structurally similar to each other and symmetrically arranged. Each locking arm 90 preferably includes a locking end 93 and a connecting end 96. An end portion of each locking end 93 preferably includes has a hook-like protrusion 95 bent toward the locking arm 90. A latch spring 100 preferably maintains the two locking arms 90 in a biased condition relative to each other. A spring force is thus applied between the locking arms 90 and the respective locking ends 93 of the locking arms 90 are biased away from each other.

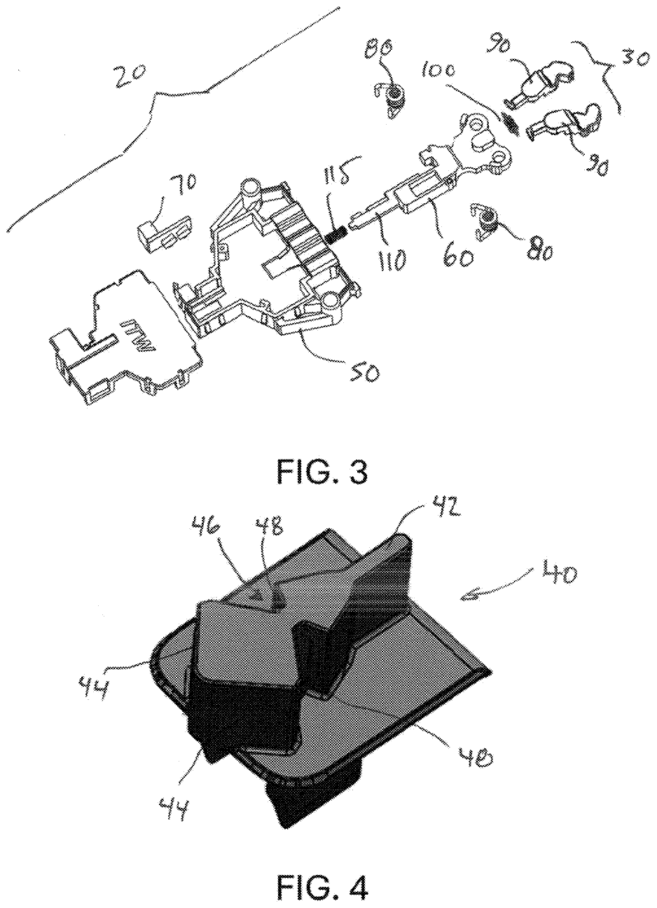

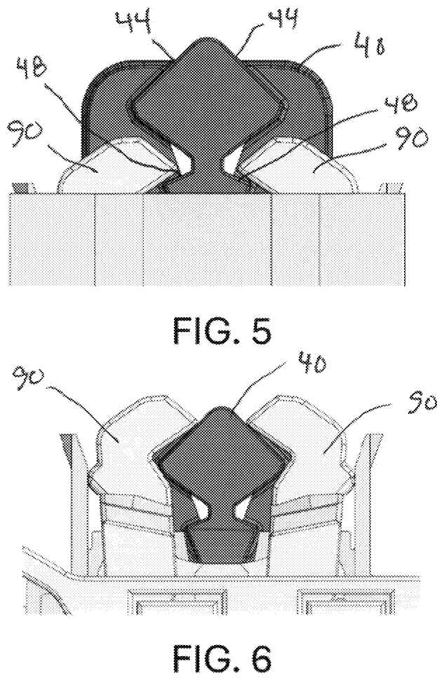

As best shown in FIG. 4, a striker 40 is preferably provided in a door of the appliance. The striker 40 is engageable with the latch 30 as shown in FIGS. 5 and 6. Specifically, the striker 40 preferably comprises a leading rib 42 and a pair of angled rear faces 44, wherein the angled rear faces 44 are engageable with the latch 30 in the locked position, shown in FIG. 6. The leading rib 42 is preferably engageable with at least one of the slider 60 and/or the secondary slider 110 when in the locked position shown in FIG. 6.

In addition, as best shown in FIG. 4, the striker 40 preferably further comprises a pinched middle engagement area 46 having a pair of angled middle faces 48, wherein the angled middle faces 48 are engageable with the latch 30 in the intermediate position, such as shown in FIG. 5.

As described above, and shown in FIGS. 5 and 6, the latch 30 comprising two locking arms 90 is provided within the housing 50, wherein the latch 30 is movable with respect to the housing 50 among a locked position (FIG. 6), an intermediate position (FIG. 5), and a released, or open, position (FIG. 1). The slider 60 is thus connected to the latch 30 to permit forward and backward movement within the housing 50 so that the latch 30 moves among the locked position, the intermediate position, and the released position relative to the striker 40.

Functionally, the pair of locking arms 90 comprising the latch 30 are configured to retain the striker 40 between the pair of locking arms 90, and the locking ends 93 of the pair of locking arms 90 are configured to prevent the striker 40 from being disengaged from the pair of locking arms 90 without specific action from the user. The pair of protrusions 95 are thus located on one side of the striker 40 in the movement direction of the slider 60 to prevent the striker 40 from moving toward the locking ends 93 in the movement direction of the slider 60.

In practice, as the appliance door is closed, the striker 40 touches the latch 30 and slider 60, which are preferably connected to two over-center slider springs 80. When the door is closed further the slider springs 80 go over center, the locking arms 90 are cammed around the back side of the striker 40 and pull the door closed. The striker 40 preferably contacts the secondary slider 110 which may be embedded within the slider 60, that closes a switch in the switch assembly 70. This allows the appliance's electronic control to know when the door is closed and it can begin a cycle, such as a wash cycle in a dishwasher. The cycle will preferably not run when the door is open.

The subject invention preferably includes the intermediate position of the latch 30 and striker 40 which is alternatively termed a “self-healing” striker. If the door lock mechanism is tampered with and goes into the door closed position, the slider 60 preferably pulls the locking arms 90 back. Since the door is open, the appliance door (dishwasher) gasket does not stop the motion of the mechanism, so it pulls all the way back. With prior art strikers, the consumer would have to push very hard to fit the latch 30 into the striker 40. The latch walls would have to flex, and the dishwasher gasket would have to be fully compressed to insert the striker 40 into the latch 30, if possible at all.

The subject self-healing striker 40 includes at least three features described above. The striker 40 includes (1) a leading rib 42 to actuate the switch assembly when the door is closed; (2) a rear face 44 for the locking arms 90 to engage during normal door opening and closing operations; and (3) a self-healing feature in a central area of the striker 40. The self-healing feature is preferably a pinched middle 46, i.e., a narrower profile than an overall width of the striker 40 to minimize the force required to insert the striker 40 into the tripped latch 30. And since the self-healing feature, specifically the angled middle faces 48, are closer to the latch 30 than the rear faces 44, the gasket will not need to be compressed during self-healing, which will minimize the self-healing force needed. In addition, the door switch will not be turned on during self-healing mode, preventing the appliance from running with the door partially open.

An additional feature of the subject invention is a laterally flexible installation alignment. When an appliance, such as a dishwasher is installed, it is common for the installation process to inadvertently push the dishwasher tub sideways, especially if the kitchen cabinet is not square or plumb. This can cause the striker 40 and latch 30 to be misaligned side-to-side, which leads to poor tactile feedback and potential water leakage. In the subject embodiment, with the latch 30 mounted to the appliance and striker 40 mounted to the door, it is preferably to include an adjustment mechanism on the latch 30, which is generally hidden under the countertop, rather than on the striker 40, which is near the appliance controls and touch points.

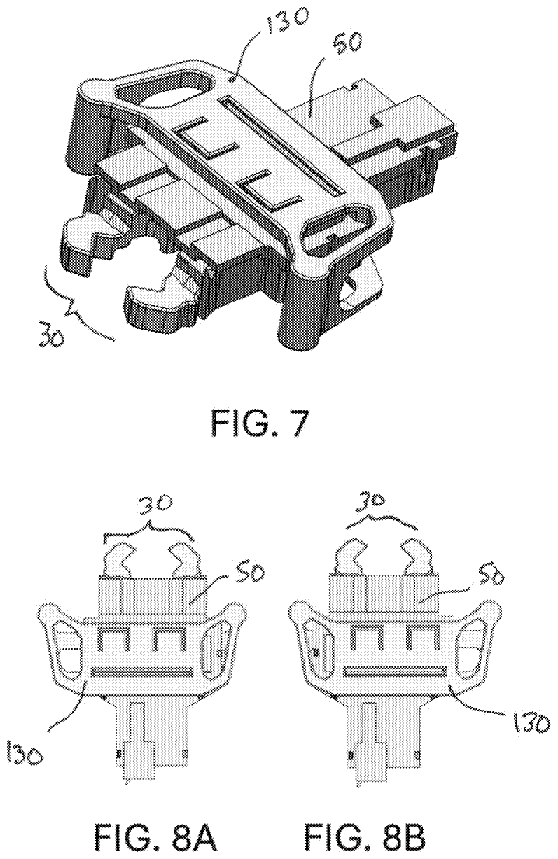

The subject invention therefore preferably includes a self-adjusting latch that adds a carriage 130 to the housing 50. FIGS. 7-10 best show this integrated carriage 130 and housing 50 embodiment. The carriage 130 is preferably positioned relative to the housing 50 so that the carriage 130 is mounted to the appliance and configured to permit the housing 50 to slide from side-to-side therein. FIG. 8A shows the housing 50 in one lateral position relative to the carriage 130 and FIG. 8B shows the housing 50 in an opposite lateral position relative to the carriage 130.

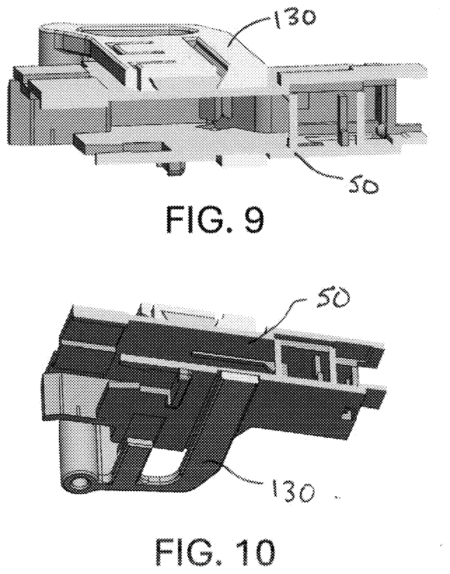

As shown in FIGS. 9 and 10, the carriage 130 and housing 50 preferably dovetail together. The dovetail design absorbs the normal door opening and closing forces, but allows the housing 50 to move side-to-side to align with the striker 40. After the appliance, such as a dishwasher, is installed, the first door closure will push the latch 30 sideways to align it with the striker 40. The latch 30 and striker 40 will subsequently be perfectly aligned for subsequent door openings and closures.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. Furthermore, the technical effects and/or technical problems described in this description are exemplary rather than limiting; therefore, the disclosure in this specification may be used to solve other technical problems and may have other technical effects. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

1. A door lock assembly for use with an appliance having a door, the door lock assembly comprising:
a housing positioned with respect to the appliance;
a latch provided within the housing, wherein the latch is movable with respect to the housing among a locked position, an intermediate position, and a released position;
a slider connected to the latch, wherein the slider is configured to be movable forward and backward within the housing so that the latch moves among the locked position, the intermediate position, and the released position; and
a striker positioned with respect to the door, the latch engageable with the striker in the locked position and the intermediate position.

2. The door lock assembly of claim 1 wherein the latch comprises two locking arms.

3. The door lock assembly of claim 1 wherein the locking arms are held open with a latch spring.

4. The door lock assembly of claim 1, further comprising:
a slider spring connected with respect to the slider and configured to apply a spring force to the slider.

5. The door lock assembly of claim 1 further comprising a carriage positioned relative to the housing, the carriage mounted to the appliance and configured to permit the housing to slide from side-to-side therein.

6. The door lock assembly of claim 5 wherein the carriage is dovetailed to the housing to permit side-to-side sliding engagement.

7. The door lock assembly of claim 1 wherein the striker comprises a leading rib and a pair of angled rear faces, the angled rear faces engageable with the latch in the locked position.

8. The door lock assembly of claim 7 further comprising a pinched middle engagement area having a pair of angled middle faces, the angled middle faces engageable with the latch in the intermediate position.

9. The door lock assembly of claim 1, wherein the latch comprises a pair of locking arms, wherein each of the pair of locking arms comprises locking ends being movable toward or away from each other to allow the pair of locking arms to reach the locked position, the intermediate position, and the released position.

10. The door lock assembly of claim 9, wherein the pair of locking arms are configured to retain the striker between the pair of locking arms, and the locking ends of the pair of locking arms are configured to prevent the striker from being disengaged from the pair of locking arms.

11. The door lock assembly of claim 10, wherein the locking ends of the pair of locking arms comprise a pair of protrusions bent toward each other, wherein when the pair of locking arms are in the locked position, the pair of protrusions are located on one side of the striker in the movement direction of the slider to prevent the striker from moving toward the locking ends in the movement direction of the slider.

12. The door lock assembly of claim 1, wherein the door lock further comprises a switch assembly transitioning from a first switch state to a second switch state when the latch moves between positions.

13. A door lock assembly for an appliance having a door, the door lock assembly comprising:
a housing;
a latch provided within the housing, wherein the latch unit is movable with respect to the housing among a locked position, an intermediate position, and a released position;
a slider connected to the latch, wherein the slider is configured to move frontward and backward to enable the latch to move from the released position to the intermediate position to the locked position and back; and
a striker positioned with respect to the door, the latch engageable with the striker in the locked position, the intermediate position, and the released position, wherein the striker includes a leading rib, a pair of angled rear faces, and a pinched middle engagement area having a pair of angled middle faces.

14. The door lock assembly of claim 13 wherein the latch comprises two locking arms.

15. The door lock assembly of claim 14 wherein the locking arms are held open with a latch spring.

16. The door lock assembly of claim 13, further comprising:
a slider spring connected with respect to the slider and configured to apply a spring force to the slider.

17. The door lock assembly of claim 13 further comprising a carriage positioned relative to the housing, the carriage mounted to the appliance and configured to permit the housing to slide from side-to-side therein.

18. The door lock assembly of claim 17 wherein the carriage is dovetailed to the housing to permit side-to-side sliding engagement.
